(19) United States
(12) Patent Application Publication
(10) Pub. No.: US 2020/0183580 A1
(43) Pub. Date: Jun. 11, 2020

(54) TOUCH-SENSITIVE INPUT WITH CUSTOM VIRTUAL DEVICE REGIONS

(71) Applicant: Cirque Corporation, Salt Lake City, UT (US)

(72) Inventors: JON BERTRAND, Taylorsiville, UT (US); MIKE LAYTON, Salt Lake City, UT (US)

(21) Appl. No.: 16/210,185

(22) Filed: Dec. 5, 2018

(51) Int. Cl. G06F 3/0488; G06F 3/044; G06F 3/041; G06F 3/0484

(52) U.S. Cl. CPC G06F 3/04886; G06F 3/044; G06F 2203/04103; G06F 3/04845; G06F 3/04847; G06F 3/0416

(57) ABSTRACT

Systems and methods for manufacturing are disclosed for a touchpad system including a touchpad having a plurality of electrodes, a touch controller operatively in communication with the plurality of electrodes, a configuration module in communication with the touch controller to configure at least one virtual device region on the touchpad, and an overlay positionable on the touchpad to indicate at least the location of the at least one virtual device region on the touchpad.

### FIELD OF THE DISCLOSURE

This disclosure relates generally to touchpad devices. In particular, this disclosure relates to user reconfigurable and customizable touchpad devices.

### BACKGROUND

Generally, a given input device (e.g., a keyboard, a mouse, a touchpad, or the like) is dedicated to a specific type of functionality. For example, keyboards are generally used for inputting text characters, a mouse is generally used to position a cursor and select items by clicking a button, and a touchpad generally allows a finger or stylus to position a cursor, select items by tapping, or allow other gestures (swipes, pinches, etc.) to manipulate a display, or the like. However, it is often inconvenient, expensive, impractical, or the like, to include multiple types of input devices for a given host device. Furthermore, different applications running on a single processor-based host device (e.g., a laptop or desktop computer) may require different types of input and input devices.

Relatedly, in touchpad design it is common to deliver specifications or requirements of a desired touchpad device to a touchpad designer and/or manufacturer, including shape, dimensions, and special features such as buttons or scrolling regions. It is then up to the designer/manufacturer to create proto-types or drawings of what is desired so that the customer can evaluate the design and determine if changes need to be made. This process may go back and forth between designers and the customer through several iterations until a desired design is obtained.

The above process can be time consuming and inconvenient. An alternative is to take an existing product and simply design the customer's device around an already existing design, even if it does not provide all of the desired features. However, this alternative approach is obviously less desirable.

Other systems and methods exist for providing a number of overlays to use over a touchpad, each designed for a different application. However, this typically requires the purchase, storage, and switching of overlays as applications are changed. Other drawbacks, inconveniences, and issues with existing devices and methods also exist.

### SUMMARY

Accordingly, disclosed embodiments address the above-noted, and other, drawbacks, inconveniences, and issues with existing devices and methods. In one disclosed embodiment there is provided a configurable touchpad system including a touchpad having a plurality of electrodes, a touch controller operatively in communication with the plurality of electrodes, and a configuration module in communication with the touch controller to configure at least one virtual device region on the touchpad.

In further disclosed embodiments, the system includes a device selection module in communication with the configuration module and that configures a type of device for the at least one virtual device region on the touchpad. Further disclosed embodiments include a touch mode module in communication with the configuration module and that configures a sensing mode of the at least one virtual device region on the touchpad.

Further disclosed embodiments include an overlay module in communication with the configuration module and that configures the at least one virtual device region based at least in part on the placement of an overlay on the touchpad. In still further disclosed embodiments, the placement of on overlay on the touchpad is sensed by the touchpad.

Further disclosed embodiments include a data format module in communication with the configuration module and that communicates to the touch controller an appropriate data format corresponding to a type of device configured on the at least one virtual device region on the touchpad.

Further disclosed embodiments include a display responsive to sensed touches on the touchpad, and an overlay module in communication with the configuration module to illuminate on the display the location of the at least one virtual device region on the touchpad. In still further disclosed embodiments, the illumination on the display further comprises displaying an image on the display.

Further disclosed embodiments include a touch controller that has at least one formatting module that formats sensed touch data from the plurality of electrodes. In further disclosed embodiments, the at least one formatting module formats sensed touch data from the plurality of electrodes according to a device type configured by the configuration module.

Further disclosed embodiments include a touchpad system having a touchpad having a plurality of electrodes, a touch controller operatively in communication with the plurality of electrodes, a configuration module in communication with the touch controller to configure at least one virtual device region on the touchpad, and an overlay positionable on the touchpad to indicate the location of the at least one virtual device region on the touchpad. In further disclosed embodiments, the overlay indicates the function of the at least one virtual device region on the touchpad. In still further embodiments, the overlay is releasably and repeatably affixable on the touchpad. In still further embodiments, the overlay includes a detectable region that is detectable by the touchpad. In still further embodiments, the detectable region may include a material such as conductors, dielectrics, and ferromagnetic materials.

Also disclosed are methods of manufacturing a touchpad system, the methods including providing a touchpad having a plurality of electrodes, providing a touch controller operatively in communication with the plurality of electrodes, providing a configuration module in communication with the touch controller to configure at least one virtual device region on the touchpad, and providing an overlay positionable on the touchpad to indicate the location of the at least one virtual device region on the touchpad. Further disclosed embodiments include using the overlay to indicate the function of the at least one virtual device region on the touchpad. In still further disclosed embodiments, the overlay is releasably and repeatably affixable on the touchpad. Further disclosed embodiments include detecting with the touchpad a detectable region on the overlay.

Other advantages, conveniences, and benefits of the disclosed systems and methods also exist.

### BRIEF DESCRIPTION OF THE DRAWINGS

FIG. 1 is a schematic block diagram of an example of a capacitive touchpad system.

FIG. 2 is a schematic block diagram of a configurable capacitive sensing device in accordance with disclosed embodiments.

FIG. 3 is a schematic block diagram of a touch controller and associated virtual reporting data protocols for a configurable capacitive sensing device in accordance with disclosed embodiments.

FIG. 4 is a schematic block diagram of a configuration module in accordance with disclosed embodiments.

FIGS. 5A-5F are exemplary overlays that may be used in conjunction with virtual device regions in accordance with the disclosure.

FIG. 6 is an isometric schematic view of a device having a touchpad and a display in accordance with disclosed embodiments.

FIG. 7 is a flow diagram illustrating a method of manufacture of a touchpad system with configurable virtual device regions in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

It should be understood that use of the term “touch sensor” throughout this document may be used interchangeably with “capacitive touch sensor,” “capacitive sensor,” “capacitive touch and proximity sensor,” “proximity sensor,” “touch and proximity sensor,” “touch panel,” “touchpad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

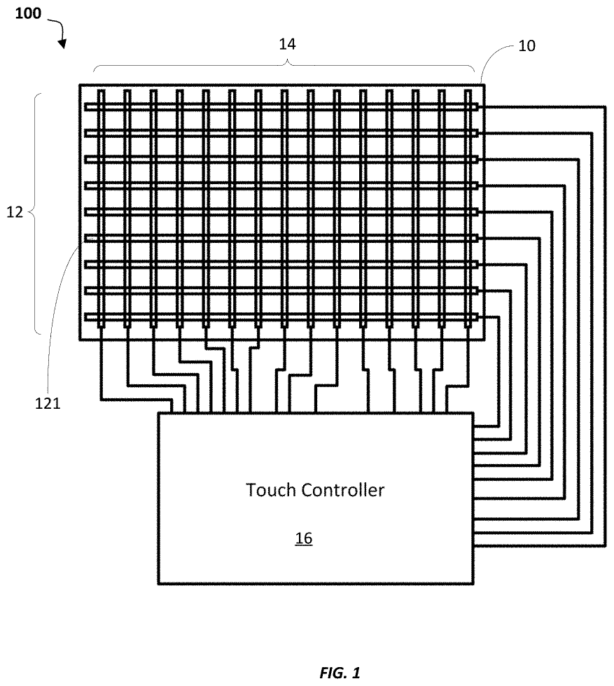

The present invention utilizes touchpad technology from CIRQUE® Corporation. Accordingly, it is useful to understand operation of the touchpad technology to a degree. The touchpad technology from CIRQUE® Corporation is a mutual capacitance sensing device 100 and an example is illustrated in FIG. 1. For this device 100 a touchpad 10 having a grid of row 12 and column 14 electrodes is used to define the touch-sensitive area of the touchpad 10. Typically, the touchpad is configured as a rectangular grid of an appropriate number of electrodes (e.g., 8-by-6, 16-by-12, 9-by-15, or the like).

As shown in FIG. 1, the mutual capacitance sensing device 100 also includes a touch controller 16. Touch controller 16 typically includes at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

Typically, touch controller 16 also includes at least one multiplexing circuit to alternate which of the row 12 or column 14 electrodes are operating as a drive electrode or a sense electrode. The driving electrodes can be driven one at a time in sequence, or randomly, or all at the same time in encoded patterns. Other configurations are possible such as self capacitance mode where the electrodes are driven and sensed simultaneously. Electrodes may also be arranged in non-rectangular arrays, such as radial patterns, linear strings, or the like. Other configurations are also possible.

Typically, no fixed reference point is used for measurements. Touch controller 16 generates signals that are sent directly to the row 12 and column 14 electrodes in various patterns.

The touchpad 10 does not depend upon an absolute capacitive measurement to determine the location of a finger (or stylus, pointer, or other object) on the touchpad 10 surface. The touchpad 10 measures an imbalance in electrical charge to the electrode functioning as a sense electrode (exemplarily illustrated as row electrode 121 in FIG. 1, but can be any of the row 12, column 14, or other dedicated-sense electrodes). When no pointing object is on or near the touchpad 10, the touch controller 16 is in a balanced state, and there is no signal on the sense electrode (e.g., electrode 121). When a finger or other pointing object creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14.

It should also be understood that touchpad technology is only one type of technology usable with the present disclosure. Accordingly, the presently disclosed embodiments may be implemented for electromagnetic, inductive, pressure sensing, electrostatic, ultrasonic, optical, resistive membrane, semi-conductive membrane, or other finger or stylus-responsive technology.

As discussed above, it is often desirable to enable a user to reconfigure a touchpad. FIG. 2 is a schematic block diagram of a configurable capacitive sensing device 200 in accordance with disclosed embodiments. As shown, a touchpad 210 may be subdivided into a number of virtual device regions (e.g., virtual device regions 212, 214, 216, 218). Virtual device regions 212, 214, 216, 218 can be configured to operate as a variety of human interface devices (HIDs), non-HIDs, or the like. For example, virtual device region 212 may be configured to function as a knob, or other radial, or rotary motion device such as a volume knob that when “turned” (i.e., by operating in a relative or rotational mode to sense a clockwise or counter-clockwise motion of a finger or other pointer object) it functions to increase (or decrease) an audible volume level on another system (e.g., speakers). In another example, virtual device region 214 may be configured to function as a button, such as an enter key on a keyboard, or the like.

In still other examples, virtual device region 216 may be configured to function as an absolute mode touchpad (e.g., for enabling signatures, or other drawing-type functions) and virtual device region 218 may be configured to function as a relative mode touchpad (e.g., to sense swipes, scrolls, pointer control, and other gestures). As one of ordinary skill in the art having the benefit of this disclosure would understand, other modes (e.g., absolute, relative, rotational, polar, or the like), configurations, functionalities, and types of virtual device regions are also possible.

As also shown in FIG. 2, touchpad 210 is in communication with a touch controller 16 to, among other things, control operation of the electrodes (not shown in FIG. 2) to sense the various types of touches as described herein. In addition, touch controller 16 is in communication with a configuration module 220 that enables the configuration of the various virtual device regions (e.g., 212, 214, 216, 218) as disclosed herein. Additionally, touch controller 16 and configuration module 220 may also communicate with a variety of other systems 222 that can vary in accordance with the host environment that the touchpad 210 is installed (e.g., a laptop, a point-of-sale terminal, a vehicle, a virtual or augmented reality device, a gaming system, or the like). While shown schematically as separate components, it is also possible to include configuration module 220 and at least portions of other systems 222 within touch controller 16, or in some other networked or distributed configuration.

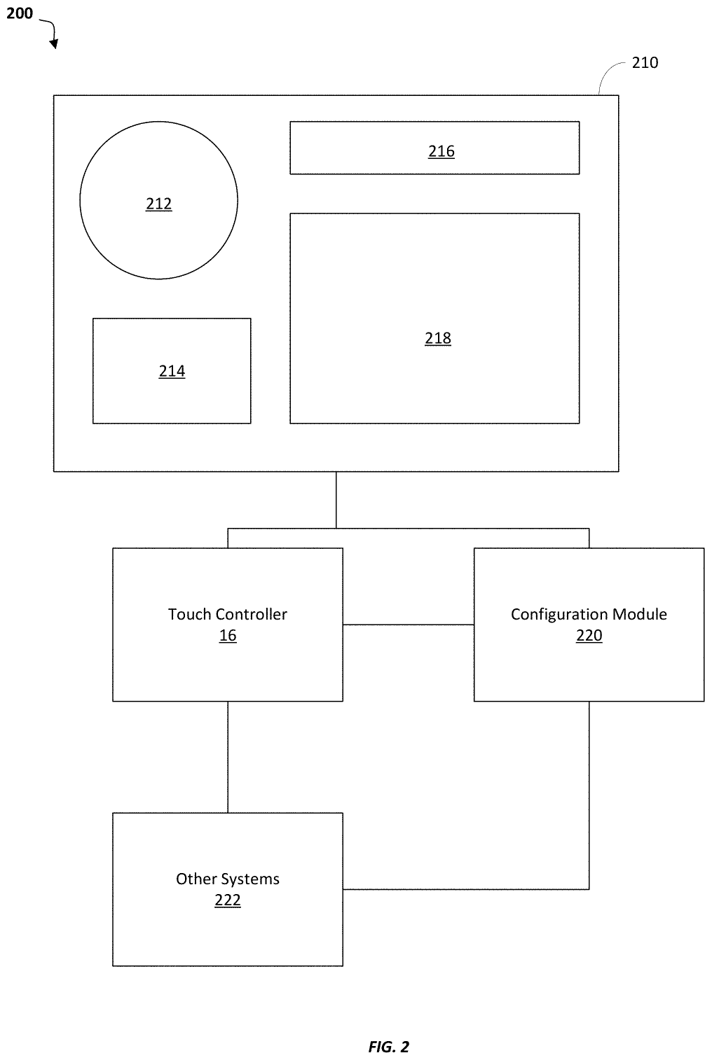

FIG. 3 is a schematic block diagram of a touch controller 16 for a configurable capacitive sensing device 200 in accordance with disclosed embodiments. As shown in this example, touchpad 210 is configured into a number of virtual device regions 212, 214, 216, 218. In this example, virtual device region 212 may be configured as a rotary knob that reports relative mode data (e.g., clockwise, counter-clockwise motion), virtual device region 214 may be configured as a number keypad that reports data corresponding to the “key” that has been pressed, virtual device region 216 may be configured as a scroll bar that reports absolute mode data (e.g., X-Y location of touch or swipe), and virtual device region 218 may be configured as touchpad region that reports absolute mode data (e.g., X-Y position of the sensed touch). Other types and combinations of data reporting are also possible.

As would be understood by a person of ordinary skill having the benefit of this disclosure, touchpad 210, senses and reports data that corresponds to the sensed change in capacitance of the constituent electrodes (e.g., 12, 14) as described above with respect to FIG. 1. As indicated schematically by the arrows on FIG. 3, that sensed touch data is communicated to touch controller 16. As also indicated schematically, touch controller comprises a number of formatting modules 30 that format the sensed touch data according to the format for the type of virtual device that has been configured (e.g., using configuration module 220). For example, when virtual device region 212 is configured as a rotary knob, the sensed data of a clockwise or counter-clockwise rotation, and the amount of the turn (e.g., full turn, ½ turn, 2 full turns, ¾ turn, etc.,) is communicated to knob formatter 302 that formats the sensed data in accordance with the type or collection of data that the host 34 (e.g., a laptop in this example) expects for a rotary knob. That formatted data is then reported and packaged a sent over a physical communication link 32 (typically, USB or I2C) to host 34 and translated by the host 34 so that the appropriate response can be delivered by host 34 (e.g., increase/decrease speaker volume corresponding to direction and amount turned).

Likewise in this example, virtual device region 216 is configured as a scroll bar, and the sensed data of the touch location (or swipe) is communicated to scroll formatter 304 and formatted to report the scroll position (and/or duration, direction, or the like) that is then packaged and reported to host 34 and responded to accordingly (e.g., the display moves according to the scroll). Similarly, virtual device region 218 is configured as a touchpad, and the sensed data of the touch location (or tap, double-tap, swipe, or other gesture) is communicated to touchpad formatter 306 where it is formatted, reported and packaged for communication to host 34 for an appropriate response (e.g., move a cursor, click a button, etc.). As would be understood by a person of ordinary skill having the benefit of this disclosure, in some embodiments when a virtual device region is configured as a touchpad (e.g., FIG. 3, region 218) the sensed data may not require additional formatting beyond the ordinary touchpad data reporting as that is the expected reporting to the host 34 from a touchpad device. Also in this example, virtual device region 214 is configured as a keypad and sensed data corresponding to the touched key(s) is communicated to keypad formatter 30n and formatted to correspond to the data format for the appropriate key(s) that is then packaged as data packet 32 and communicated to host 34 for the appropriate response (e.g., display numbers pressed, dial phone, or the like).

As would be understood by a person of ordinary skill having the benefit of this disclosure, and as indicated schematically in FIG. 3, any number of formatting modules 30 may be included in touch controller 16. Further, while indicated as separate modules, a single formatting module 30 may handle data formatting for any number of virtual device regions, and other types of virtual devices, data formats, and the like may also be used, and the formatting modules 30 may comprise software, firmware, hardware, or combinations of the same.

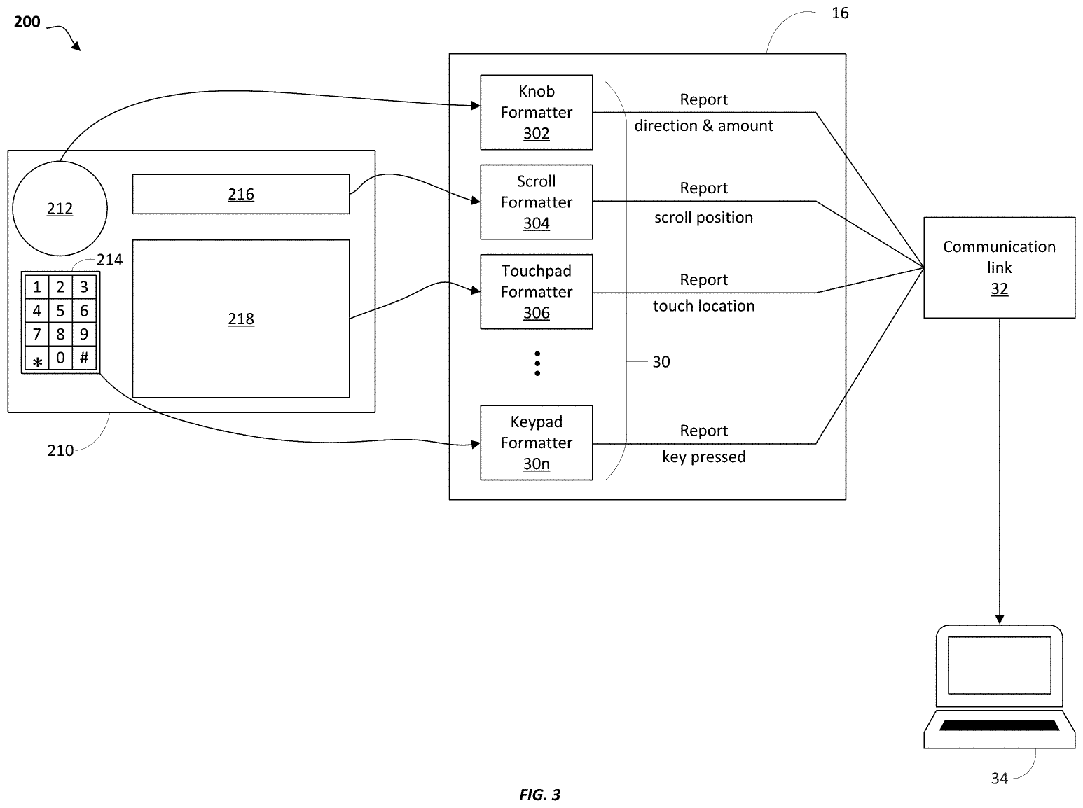

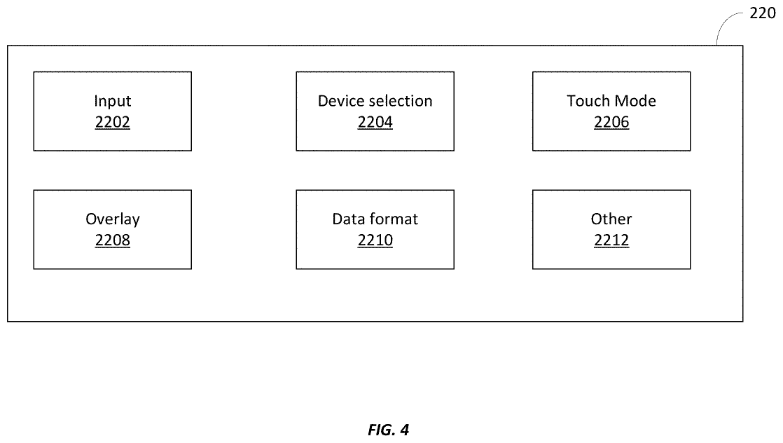

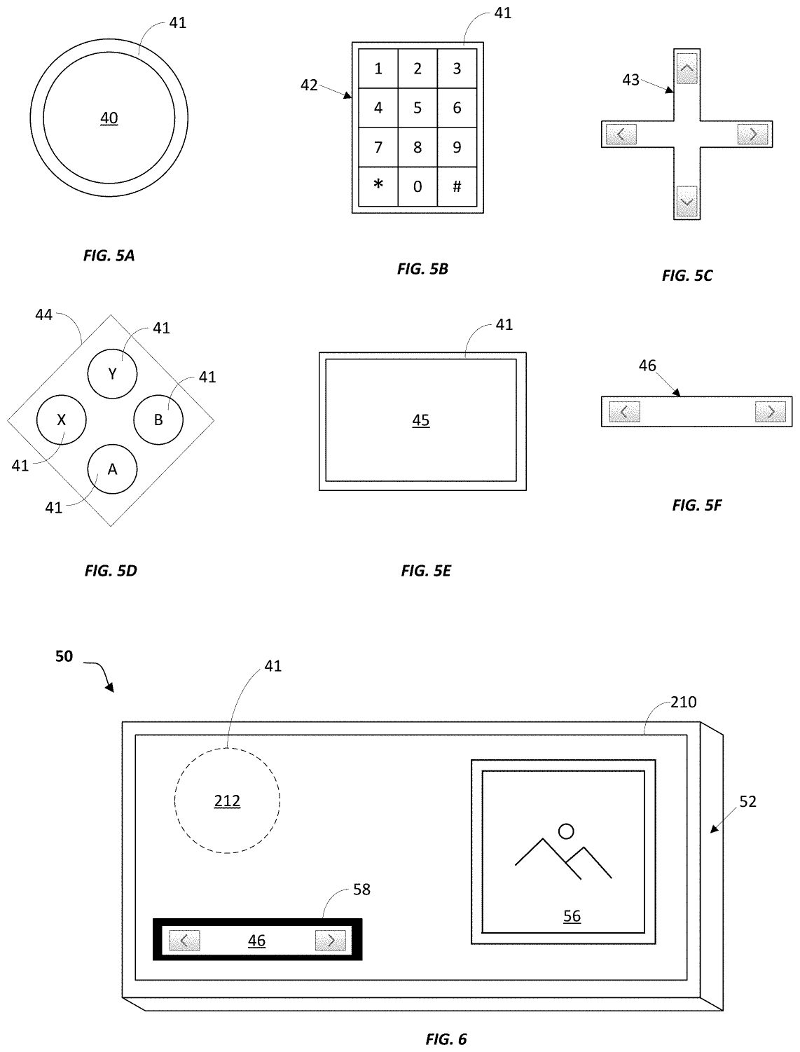

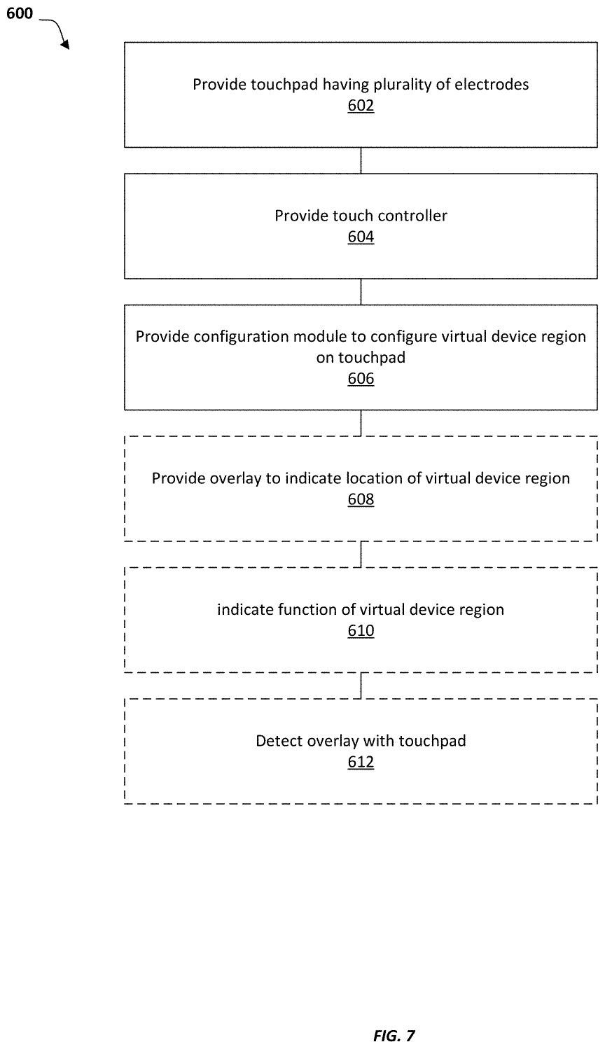

FIG. 4 is a schematic block diagram of a configuration module 220 in accordance with disclosed embodiments. As shown, a number of submodules comprising software, firmware, hardware, or combinations of the same, may be included within configuration module 220. For example, and as shown on FIG. 4, configuration module may include a user input module 2202 to enable the user to input selections or the like to configure touchpad 210, a device selection module 2204 to enable configuration of virtual device regions (e.g., 212, 214) as knobs, buttons, scroll bars, or the like, a touch mode module 2206 to enable configuration of virtual device regions (e.g., 216, 218) as absolute mode, relative mode, rotational mode, or other mode touchpads, an overlay module 2208 to configure the virtual device regions in connection with an overlay as described below with reference to FIGS. 5-6, a data format module 2210 to communicate to touch controller 16 the types and format for the data corresponding to the device selected, and other modules 2212 to enable other operations of the configuration module 220. As discussed above in connection with FIG. 3, the virtual device regions (212, 214, 216, 218) are assigned appropriate usages and value ranges for the quantities they report, which are communicated to the host 34 in a report descriptor. The sensed data are then formatted by the formatting modules 30 according to the report descriptor to enable the host 34 to properly interpret the input. For example, in a Microsoft Windows based host 34, if a region was configured to be used for stylus writing, it will appear as a Digitizer device with a Stylus collection that reports the coordinates of the tip of the stylus, as well as input from other controls that would normally be located on an actual stylus. A normal touchpad function would make the region appear as a Digitizer device with a Touch Pad collection, reporting the X-Y coordinates of one or more fingers, as well as other data associated with touch input.

FIGS. 5A-5F are exemplary overlays that may be used in conjunction with virtual device regions in accordance with the disclosure. Embodiments of the overlays may comprise a decal, label, sticker, or the like, that is positioned on the touchpad (e.g., touchpad 210) to assist in locating the virtual device region, to give an indication of the function of the virtual device region, to configure the virtual device region, or the like, as disclosed herein. For example, FIG. 5A shows a circular overlay 40 that may be used in conjunction with a knob-type virtual device region, such as is disclosed above in virtual device region 212.

Embodiments of the overlays may include a conductive, dielectric, magnetic, or otherwise detectable region 41 that may be detected by a touchpad (e.g., touchpad 210 in communication with touch controller 16) and configured by configuration module 220. Configuration may occur automatically (i.e., without user input), by prompted user input, or the like.

Embodiments of the overlays may use permanent, semi-permanent, or reusable adhesives to adhere to the touchpad surface. Other embodiments may use vinyl or other plastic materials that adhere via electrostatics or the like. Still other embodiments of the overlays may comprise magnetic or ferromagnetic materials adhere via magnetic attraction. Other attachment systems may also be used as would be apparent to persons of ordinary skill having the benefit of this disclosure.

As illustrated in FIGS. 5A-5F overlays may be designed for a variety of virtual device region purposes. For example, FIG. 5B illustrates a numeric keypad overlay 42 that overlays a virtual device region configured to function as a calculator, PIN entry point, telephone dial, or the like as described above in conjunction with FIG. 3, virtual device region 214. Likewise, FIG. 5C illustrates a directional cross overlay 43 that overlays a virtual device region configured to function as a directional game controller or the like. FIG. 5D illustrates another embodiment of an overlay comprising game controller buttons 44 (e.g., the X-Y-A-B buttons on some game controllers) where the button portions comprise the detectable region 41 (e.g., they are conductive, dielectric, magnetic, or the like). FIG. 5E illustrates an overlay 45 that overlays a virtual device region configured to function as a touchpad, signature block, or the like (e.g., FIG. 3, virtual device region 218 described above). FIG. 5F illustrates a scroll bar overlay 46 that overlays a virtual device region configured to function such that when the touch is further to the right accelerate, the scroll accelerates more to the right and when the touch is farther to the left, the scroll accelerates more to the left (e.g., FIG. 3, virtual device region 216 described above). Other overlays may also be used as would be apparent to persons of ordinary skill having the benefit of this disclosure.

FIG. 6 is an isometric schematic view of a device 50 having a touchpad 210 and a display 52 in accordance with disclosed embodiments. For example, device 50 may comprise a tablet, smart phone, or the like, with a touchpad 210 that operates in front of, on top of, underneath, or integrated into, a display screen 52 or the like. In accordance with disclosed embodiments, a virtual device region (e.g., region 212) may be indicated on the display 52 by an illuminated area 54 or the like. Likewise, an image 56 may appear on display 52 indicating the presence of a virtual device region, or an outline 58 may be displayed to indicate where an overlay (e.g., scroll bar overlay 46) should be adhered. Other display items may also be used as would be apparent to persons of ordinary skill having the benefit of this disclosure

FIG. 7 is a flow diagram illustrating a method of manufacture 600 of a touchpad system with configurable virtual device regions in accordance with disclosed embodiments. As indicated, the method 600 comprises providing at 602 a touchpad (e.g., 210) comprising a plurality of electrodes (e.g., 12, 14). At 604, providing a touch controller (e.g., 16) operatively in communication with the plurality of electrodes. At 606, providing a configuration module (e.g., 220) in communication with the touch controller to configure at least one virtual device region (e.g., 212, 214, 216, 218) on the touchpad.

Embodiments of the method may optionally include at 608 providing an overlay (e.g., 40, 42, 43, 44, 45, 46) positionable on the touchpad to indicate the location of the at least one virtual device region on the touchpad, and at 610 using the overlay to indicate the function of the at least one virtual device region on the touchpad. Likewise, embodiments of the method may optionally include at 612 detecting with the touchpad a detectable region on the overlay. One of ordinary skill in the art having the benefit of this disclosure would understand that other methods of manufacture and operation are also possible.

Although various embodiments have been shown and described, the present disclosure is not so limited and will be understood to include all such modifications and variations are would be apparent to one skilled in the art.

1. A configurable touchpad system comprising:
a touchpad comprising a plurality of electrodes;
a touch controller operatively in communication with the plurality of electrodes;
a configuration module in communication with the touch controller to configure at least one virtual device region on the touchpad; and
a device selection module in communication with the configuration module and that configures the at least one virtual device region to be a human interface device on the touchpad.

2. (canceled)

3. The system of claim 1 further comprising:
a touch mode module in communication with the configuration module and that configures a sensing mode of the at least one virtual device region on the touch pad.

4. The system of claim 1 further comprising:
an overlay module in communication with the configuration module and that configures the at least one virtual device region based at least in part on the placement of an overlay on the touchpad.

5. The system of claim 4 wherein the placement of the overlay on the touchpad is sensed by the touchpad.

6. The system of claim 1 further comprising:
a data format module in communication with the configuration module and that communicates to the touch controller an appropriate data format corresponding to a type of device configured on the at least one virtual device region on the touchpad.

7. The system of claim 1 further comprising:
a display responsive to sensed touches on the touchpad; and
an overlay module in communication with the configuration module to illuminate on the display the location of the at least one virtual device region on the touch pad.

8. The system of claim 7 wherein the illumination on the display further comprises displaying an image on the display.

9. The system of claim 1 wherein the touch controller further comprises at least one formatting module that formats sensed touch data from the plurality of electrodes.

10. The system of claim 9 wherein the at least one formatting module formats sensed touch data from the plurality of electrodes according to a device type configured by the configuration module.

11. A touchpad system comprising:
a touchpad comprising a plurality of electrodes;
a touch controller operatively in communication with the plurality of electrodes;
a configuration module in communication with the touch controller to configure at least one virtual device region to be a human interface device on the touchpad; and
an overlay positionable on the touchpad to indicate the location of the at least one virtual device region on the touchpad.

12. The system of claim 11 wherein the overlay indicates the function of the at least one virtual device region on the touchpad.

13. The system of claim 11 wherein the overlay is releasably and repeatably affixable on the touchpad.

14. The system of claim 11 wherein the overlay further comprises:
a detectable region that is detectable by the touchpad.

15. (canceled)

16. A method of manufacturing a touchpad system comprising:
providing a touchpad comprising a plurality of electrodes;
providing a touch controller operatively in communication with the plurality of electrodes;
providing a configuration module in communication with the touch controller to configure at least one virtual device region to be a human interface device on the touchpad; and
providing an overlay positionable on the touchpad to indicate the location of the at least one virtual device region on the touchpad.

17. The method of claim 16 further comprising:
using the overlay to indicate the function of the at least one virtual device region on the touchpad.

18. (canceled)

19. (canceled)

20. (canceled)

21. The system of claim 1, wherein the human interface device is a rotary knob.

22. The system of claim 1, wherein the human interface device is a button.

23. The system of claim 1, wherein the human interface device is a scroll bar.

24. The system of claim 5, wherein the overlay is a decal.

25. The system of claim 5, wherein the overlay is a sticker.
